(19) United States
(12) Patent Application Publication
(10) Pub. No.: US 2004/0151208 A1
(43) Pub. Date: Aug. 5, 2004

(54) Parallel encoding/decoding for communications protocol

(76) Inventor: Patrick E. Maupin, Austin, TX (US)

Correspondence Address: DAVIS & ASSOCIATES, P.O. BOX 1093, DRIPPING SPRINGS, TX, 78620, US

(21) Appl. No.: 10/390,536

(22) Filed: Mar. 15, 2003

Related U.S. Application Data
(60) Provisional application No. 60/444,219, filed on Jan. 31, 2003.

(51) Int. Cl. H04J 3/00

(52) U.S. Cl. 370/476

(57) ABSTRACT

A set of a plurality of bits is processed by performing operations on the set of bits to produce a result that identifies whether the set of bits has a bit pattern and that identifies a location of the bit pattern in the set of bits. For a set of bits for an outgoing bitstream, one or more bits are inserted in the set of bits relative to the bit pattern if the set of bits has the bit pattern. For a set of bits for an incoming bitstream, one or more bits in the set of bits relative to the identified bit pattern are removed if the set of bits has the bit pattern and if the identified bit pattern comprises data bits.

This patent application claims the benefit of the Jan. 31, 2003 filing date of U.S. Provisional Patent Application No. 60/444,219, which is incorporated herein by reference.

### BACKGROUND

1. Field of the Invention

The present invention relates generally to the field of communications. More particularly, the present invention relates to the field of data encoding/decoding for communications protocols.

2. Description of Related Art

High-level Data Link Control (HDLC) is a typical data link protocol used to transmit data from one node of a network to another. HDLC is a synchronous transmission protocol, meaning the sending and receiving nodes are synchronized to one another.

The sending node defines one or more frames of data to be transmitted to the receiving node in accordance with the HDLC protocol. A frame is generally defined by a pattern of bits representing a start of frame flag, a variable number of bits representing data to be transmitted, and a pattern of bits representing an end of frame flag. The sending node transmits the frame(s) to the receiving node in a bitstream. As the receiving node receives the bitstream, the receiving node may extract the transmitted data from the bitstream by identifying the start of frame flag and the end of frame flag of the frame(s). Because the data to be transmitted may have a bit pattern that is the same as that for the start of frame flag, for the end of frame flag, or for one or more other flags as defined by the HDLC protocol, the sending node inserts or stuffs additional bits of zero value in the data to be transmitted to help the receiving node identify only true flags in the received bitstream. The receiving node may then remove the stuffed zero bits from the transmitted data as the receiving node extracts the transmitted data from the bitstream.

One typical receiving node identifies flag bit patterns and stuffed zero bits in a bitstream by executing software to implement a state machine. As each bit of the bitstream is received, the receiving node updates the state machine in accordance with the received bit until the state of the state machine identifies a flag bit pattern or stuffed zero has been received. Because the receiving node executes instructions to update the state machine in response to receiving only one bit at a time and because updating the state machine typically requires relatively slower memory accesses to read the current state of the state machine and write the updated state, the speed with which the receiving node may process a given frame or frames is limited. The receiving node also requires additional memory to store the state of the state machine.

Another typical receiving node executes software to address one or more tables using a plurality of received bits from a bitstream to derive corresponding data to be extracted from a frame in the bitstream. The receiving node requires additional read only memory (ROM) space and/or additional random access memory (RAM) space to store the table(s). Also, the speed with which the receiving node may process a given frame or frames may be limited by relatively slower memory accesses to access the table(s).

### SUMMARY

A method comprises processing a set of a plurality of bits to identify whether the set of bits has a bit pattern. The set of bits comprises a first subset of a plurality of bits to be transmitted in an outgoing bitstream appended to a second subset of one or more bits of the outgoing bitstream. The processing comprises performing operations on the set of bits to produce a result that identifies whether the set of bits has the bit pattern and that identifies a location of the bit pattern in the set of bits. The method also comprises inserting one or more bits in the first subset of bits relative to the bit pattern if the set of bits has the bit pattern and transmitting in the outgoing bitstream the first subset of bits with any inserted bits at a speed of at least 14.4 kbps.

The processing may comprise performing operations equivalent to producing one or more other sets of bits from the set of bits and logically combining the set of bits and/or the one or more other sets of bits to produce the result. The producing one or more other sets of bits from the set of bits may comprise shifting and/or inverting the set of bits. The logically combining the set of bits and/or the one or more other sets of bits may comprise performing a logical AND operation on the set of bits and/or the one or more other sets of bits.

The processing may comprise producing one or more other sets of bits from the set of bits and logically combining the set of bits and/or the one or more other sets of bits to produce the result.

The processing may comprise producing one or more other sets of bits from the set of bits, logically combining the set of bits and/or the one or more other sets of bits produced from the set of bits to produce a first intermediate result, producing one or more other sets of bits from the first intermediate result, and logically combining the first intermediate result and/or the one or more other sets of bits produced from the first intermediate result to produce a second intermediate result.

An apparatus comprises a first interface to receive data from data terminal equipment and a processor to process a set of a plurality of bits of the received data to identify whether the set of bits has a bit pattern. The set of bits comprises a first subset of a plurality of bits to be transmitted in an outgoing bitstream appended to a second subset of one or more bits of the outgoing bitstream. The processor is to perform operations on the set of bits to produce a result that identifies whether the set of bits has the bit pattern and that identifies a location of the bit pattern in the set of bits. The processor is to insert one or more bits in the first subset of bits relative to the bit pattern if the set of bits has the bit pattern. The apparatus also comprises a second interface to transmit the outgoing bitstream at a speed of at least 14.4 kbps.

The processor may perform operations equivalent to producing one or more other sets of bits from the set of bits and logically combine the set of bits and/or the one or more other sets of bits to produce the result.

The processor may produce one or more other sets of bits from the set of bits and logically combine the set of bits and/or the one or more other sets of bits to produce the result. The processor may produce one or more other sets of bits from the set of bits by shifting and/or inverting the set of bits. The processor may logically combine the set of bits and/or the one or more other sets of bits by performing a logical AND operation on the set of bits and/or the one or more other sets of bits.

The processor may produce one or more other sets of bits from the set of bits, logically combine the set of bits and/or the one or more other sets of bits produced from the set of bits to produce a first intermediate result, produce one or more other sets of bits from the first intermediate result, and logically combine the first intermediate result and/or the one or more other sets of bits produced from the first intermediate result to produce a second intermediate result.

Another apparatus comprises means for processing a set of a plurality of bits to identify whether the set of bits has a bit pattern. The set of bits comprises a first subset of a plurality of bits to be transmitted in an outgoing bitstream appended to a second subset of one or more bits of the outgoing bitstream. The means for processing comprises means for performing operations on the set of bits to produce a result that identifies whether the set of bits has the bit pattern and that identifies a location of the bit pattern in the set of bits. The apparatus also comprises means for inserting one or more bits in the first subset of bits relative to the bit pattern if the set of bits has the bit pattern and means for transmitting in the outgoing bitstream the first subset of bits with any inserted bits at a speed of at least 14.4 kbps.

The means for processing may comprise means for performing operations equivalent to producing one or more other sets of bits from the set of bits and logically combining the set of bits and/or the one or more other sets of bits to produce the result.

Another method comprises receiving an incoming bitstream at a speed of at least 14.4 kbps and processing a set of a plurality of bits from an incoming bitstream to identify whether the set of bits has a bit pattern. The processing comprises performing operations on the set of bits to produce a result that identifies whether the set of bits has the bit pattern and that identifies a location of the bit pattern in the set of bits. The method also comprises identifying whether an identified bit pattern in the set of bits comprises data bits and removing one or more bits in the set of bits relative to the identified bit pattern if the identified bit pattern comprises data bits.

The processing may comprise performing operations equivalent to producing one or more other sets of bits from the set of bits and logically combining the set of bits and/or the one or more other sets of bits to produce the result. The producing one or more other sets of bits from the set of bits may comprise shifting and/or inverting the set of bits. The logically combining the set of bits and/or the one or more other sets of bits may comprise performing a logical AND operation on the set of bits and/or the one or more other sets of bits.

The processing may comprise producing one or more other sets of bits from the set of bits and logically combining the set of bits and/or the one or more other sets of bits to produce the result.

The processing may comprise producing one or more other sets of bits from the set of bits, logically combining the set of bits and/or the one or more other sets of bits produced from the set of bits to produce a first intermediate result, producing one or more other sets of bits from the first intermediate result, and logically combining the first intermediate result and/or the one or more other sets of bits produced from the first intermediate result to produce a second intermediate result.

An apparatus comprises a first interface to receive an incoming bitstream at a speed of at least 14.4 kbps and a processor to process a set of a plurality of bits from the incoming bitstream to identify whether the set of bits has a bit pattern. The processor is to perform operations on the set of bits to produce a result that identifies whether the set of bits has the bit pattern and that identifies a location of the bit pattern in the set of bits. The processor is to identify whether an identified bit pattern in the set of bits comprises data bits. The processor is to remove one or more bits in the set of bits relative to the identified bit pattern if the identified bit pattern comprises data bits. The apparatus also comprises a second interface to transmit the set of bits to data terminal equipment.

The processor may perform operations equivalent to producing one or more other sets of bits from the set of bits and logically combine the set of bits and/or the one or more other sets of bits to produce the result.

The processor may produce one or more other sets of bits from the set of bits and logically combine the set of bits and/or the one or more other sets of bits to produce the result. The processor may produce one or more other sets of bits from the set of bits by shifting and/or inverting the set of bits. The processor may logically combine the set of bits and/or the one or more other sets of bits by performing a logical AND operation on the set of bits and/or the one or more other sets of bits.

The processor may produce one or more other sets of bits from the set of bits, logically combine the set of bits and/or the one or more other sets of bits produced from the set of bits to produce a first intermediate result, produce one or more other sets of bits from the first intermediate result, and logically combine the first intermediate result and/or the one or more other sets of bits produced from the first intermediate result to produce a second intermediate result.

Another apparatus comprises means for receiving an incoming bitstream at a speed of at least 14.4 kbps and means for processing a set of a plurality of bits from an incoming bitstream to identify whether the set of bits has a bit pattern. The means for processing comprises means for performing operations on the set of bits to produce a result that identifies whether the set of bits has the bit pattern and that identifies a location of the bit pattern in the set of bits. The apparatus also comprises means for identifying whether an identified bit pattern in the set of bits comprises data bits and means for removing one or more bits in the set of bits relative to the identified bit pattern if the identified bit pattern comprises data bits.

The means for processing may comprise means for performing operations equivalent to producing one or more other sets of bits from the set of bits and logically combining the set of bits and/or the one or more other sets of bits to produce the result.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 illustrates, for one embodiment, an example network environment;

FIG. 2 illustrates, for one embodiment, circuitry for data communications equipment (DCE);

FIG. 3 illustrates, for one embodiment, a flow diagram to receive and store data from data terminal equipment (DTE) for encoding and transmission in accordance with a communications protocol;

FIGS. 4A and 4B illustrate, for one embodiment, a flow diagram to encode and transmit data in accordance with a communications protocol;

FIG. 5 illustrates, for one embodiment, a logical combination of an example first set of bits with other example sets of bits produced from the first set of bits to identify whether the first set of bits has one or more occurrences of an example bit pattern;

FIG. 6 illustrates, for one embodiment, a logical combination of an example first set of bits with other example sets of bits produced from the first set of bits to identify whether the first set of bits has one or more occurrences of an example bit pattern;

FIGS. 7A, 7B, and 7C illustrate, for one embodiment, a flow diagram to decode received data in accordance with a communications protocol;

FIG. 8 illustrates, for one embodiment, a logical combination of example sets of bits produced from a first set of bits to identify whether the first set of bits has one or more occurrences of an example bit pattern; and

FIG. 9 illustrates, for one embodiment, a flow diagram to transmit data received and decoded in accordance with a communications protocol to data terminal equipment (DTE).

### DETAILED DESCRIPTION

The following detailed description sets forth an embodiment or embodiments in accordance with the present invention for parallel encoding/decoding for communications protocol.

### EXAMPLE NETWORK ENVIRONMENT

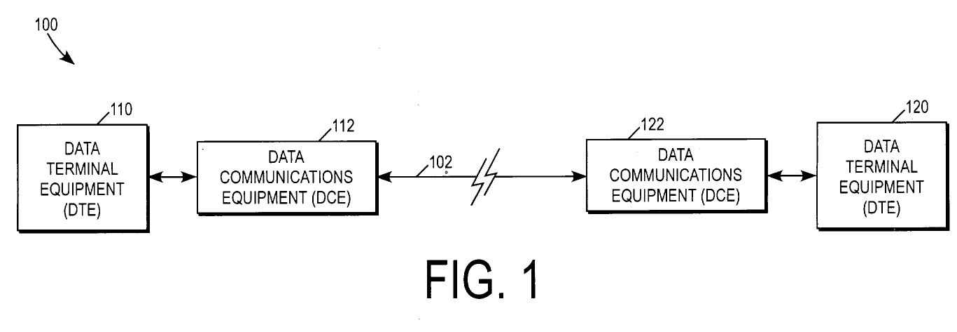

FIG. 1 illustrates, for one embodiment, a network 100 comprising data terminal equipment (DTE) 110 and 120 and data communications equipment (DCE) 112 and 122.

DCE 112 is coupled between DTE 110 and a transmission line 102. DCE 122 is coupled between DTE 120 and transmission line 102. Transmission line 102 couples DCE 112 and DCE 122. DTE 110 and DTE 120 communicate with one another using DCE 112 and DCE 122 to transmit data between DTE 110 and DTE 120.

Although illustrated as devices that are separate from DTE 110 and DTE 120, DCE 112 and DCE 122 for another embodiment may be housed within or integral with DTE 110 and DTE 120, respectively. For another embodiment, DTE 110 and/or DTE 120 may implement at least a portion of the functionality of DCE 112 and/or DCE 122, respectively, by executing suitable instructions.

DTE 110 and DTE 120 may each comprise any suitable equipment including, for example, a personal computer, a laptop or notebook computer, a tablet computer, a portable computer or personal digital assistant (PDA), a payphone, a cellular telephone, a set-top box, a personal video recorder (PVR), a point-of-sale (POS) terminal, a vending machine, a security system, a remote monitoring system, or a server system.

DTE 110 and DTE 120 may transmit any suitable data to one another. As used in this description, the term data encompasses, without limitation, information including facts, figures, database information, text information, document information, image information, audio information, and/or video information; commands; program code or instructions; network addresses; status information; and/or control information, for example.

DTE 110 transmits to DCE 112, in the form of digital signals, data to be transmitted to DTE 120. DCE 112 receives the digital signals from DTE 110, encodes the data corresponding to the received digital signals in accordance with a suitable communications protocol, converts digital signals corresponding to the encoded data into corresponding analog signals, and transmits the analog signals onto transmission line 102. DCE 122 receives the analog signals on transmission line 102, converts the received analog signals into corresponding digital signals, decodes the encoded data corresponding to the digital signals, and transmits digital signals corresponding to the decoded data to DTE 120.

DTE 120 may similarly transmit any suitable data to DTE 110 using DCE 122 to encode and transmit the data onto transmission line 102 and using DCE 112 to receive and decode the encoded data for DTE 110.

Although described as communicating electrical analog signals over transmission line 102, DCE 112 and DCE 122 may communicate with one another using any one or more suitable communication technologies including, for example, electrical analog signal technologies, electrical digital signal technologies, light or optical signal technologies, and/or wireless technologies such as, for example, infrared line of sight, cellular, microwave, satellite, packet radio, and/or spread spectrum.

DCE 112 and DCE 122 for one embodiment encode and decode data in accordance with a suitable data link protocol. DCE 112 and DCE 122 for one embodiment may be synchronized to one another and encode and decode data signals in accordance with a suitable synchronous transmission protocol. The High-level Data Link Control (HDLC) protocol and the Synchronous Data Link Control (SDLC) protocol are examples of synchronous data link protocols.

Although described in the context of communicating data between DTE 110 and DTE 120, DCE 112 and DCE 122 may be similarly used to communicate data between any two nodes of any suitable network.

Data Communications Equipment Circuitry

DCE 112 may comprise any suitable circuitry to communicate with DTE 110 and DCE 122. For one embodiment where transmission line 102 is a telephone line, DCE 112 may comprise a modem to interface DTE 110 with the telephone line. DCE 112 for one embodiment may comprise a Si2456 (56 kbps), Si2433 (33.6 kbps), or Si2414 (14.4 kbps) ISOmodem™ chipset manufactured by Silicon Laboratories, Inc. of Austin, Tex. DCE 122 may or may not comprise similar circuitry as DCE 112.

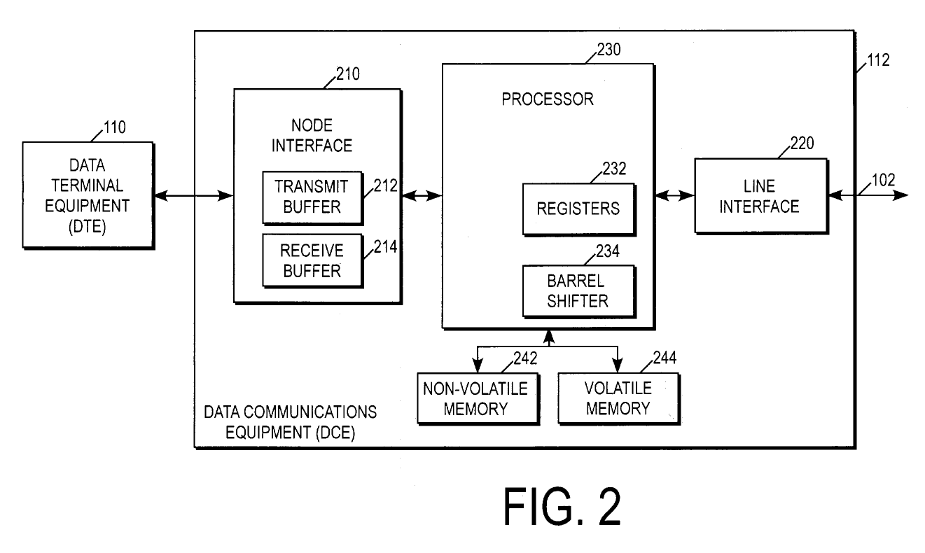

As illustrated in FIG. 2, DCE 112 for one embodiment may comprise a node interface 210, a line interface 220, a processor 230, a non-volatile memory 242, and a volatile memory 244.

Node interface 210 is to be coupled to DTE 110 to receive from DTE 110, for example, data to be transmitted onto transmission line 102 and to transmit to DTE 110, for example, data received from transmission line 102. Node interface 210 may comprise any suitable circuitry to transmit data to and to receive data from DTE 110 in any suitable manner. Node interface 210 for one embodiment may comprise a universal asynchronous receiver transmitter (UART) serial interface to transmit data to and to receive data from DTE 110 in a serial manner in accordance with a suitable asynchronous protocol. Node interface 210 for another embodiment may comprise a parallel interface to transmit data to and to receive data from DTE 110 in a parallel manner in accordance with a suitable asynchronous protocol.

Node interface 210 for one embodiment may comprise a transmit buffer 212 to store data received from DTE 110 and a receive buffer 214 to store data to be transmitted to DTE 110. Transmit buffer 212 and receive buffer 214 may comprise any suitable circuitry to store any suitable amount of data of any suitable size in any suitable manner. Transmit buffer 212 and/or receive buffer 214 for one embodiment may comprise first-in-first-out (FIFO) buffers in which a plurality of bits may be stored at a given stage.

Line interface 220 is to be coupled to transmission line 102 to transmit onto transmission line 102 data encoded in accordance with a suitable communications protocol and to receive from transmission line 102 data encoded in accordance with a suitable communications protocol. Line interface 220 may comprise any suitable circuitry to transmit data onto and to receive data from transmission line 102 in any suitable manner. Although described in connection with line interface 220, DCE 112 for another embodiment may comprise any suitable interface to communicate with DCE 122 using any one or more suitable communication technologies including, for example, electrical digital signal technologies, light or optical signal technologies, and/or wireless technologies such as, for example, infrared line of sight, cellular, microwave, satellite, packet radio, and/or spread spectrum.

Processor 230 is coupled to non-volatile memory 242 and to volatile memory 244 and is to execute instructions stored in non-volatile memory 242 and/or in volatile memory 244 to configure and control DCE 112.

Processor 230 is coupled to node interface 210 to receive from node interface 210, for example, data that is to be transmitted onto transmission line 102 and is coupled to line interface 220 to transmit to line interface 220, for example, data encoded in accordance with a suitable communications protocol. Processor 230 is to execute instructions stored in non-volatile memory 242 and/or in volatile memory 244 to encode data in accordance with a suitable communications protocol.

Processor 230 is coupled to line interface 220 to receive from line interface 220 encoded data received from transmission line 102 and is coupled to node interface 210 to transmit to node interface 210 received data decoded in accordance with a suitable communications protocol. Processor 230 is to execute instructions stored in non-volatile memory 242 and/or in volatile memory 244 to decode encoded data in accordance with a suitable communications protocol.

Processor 230 may have any suitable architecture and may comprise any suitable circuitry to configure and control DCE 112 to transmit data for DTE 110 onto transmission line 102 and to receive data for DTE 110 from transmission line 102. Processor 230 for one embodiment may comprise a set of registers 232 and/or a barrel shifter 234.

For one embodiment where DCE 112 comprises a modem, processor 230 may execute suitable instructions to provide one or more suitable functions including one or more suitable digital signal processing functions. Suitable functions may include, for example, ATtention (AT) command parsing, direct access arrangement (DAA) control, connect sequence control, communications protocol control, escape control, caller identification (ID) control and formatting, ring detect, dual tone multi-frequency (DTMF) control, call progress monitoring, error correction, data compression, modulation, demodulation, and/or echo cancellation.

Non-volatile memory 242 is to store instructions for execution by processor 230. Non-volatile memory 242 may optionally be used to store data for use by processor 230 to configure and/or control DCE 112. Non-volatile memory 242 may comprise any suitable non-volatile memory circuitry, such as that for flash memory, read only memory (ROM), programmable read only memory (PROM), erasable programmable read only memory (EPROM), electrically erasable programmable read only memory (EEPROM) and/or a battery-backed random access memory (RAM) for example.

Volatile memory 244 may optionally be used to store instructions for execution by processor 230. Volatile memory 244 may optionally be used to store data for use by processor 230 to configure and/or control DCE 112 and/or may store unencoded and/or encoded data to be transmitted onto transmission line 102 and/or encoded and/or decoded data received from transmission line 102. Volatile memory 244 may comprise any suitable volatile memory circuitry, such as that for random access memory (RAM), static random access memory (SRAM), dynamic random access memory (DRAM), and/or synchronous dynamic random access memory (SDRAM) for example.

Although described in the context of instructions stored in non-volatile memory 242 and/or volatile memory 244 to be executed by processor 230, any suitable machine-executable instructions that provide parallel encoding and/or decoding for a communications protocol may be stored on any suitable machine-readable medium, such as a hard disk device, a floppy disk or diskette device, an optical disk device such as a compact disc (CD) or digital versatile disc (DVD) device for example, a Bernoulli disk device such as a Jaz or Zip disk device for example, a flash memory device, a file server device, and/or any other suitable memory device, for execution by any suitable machine.

Data Encoding and Transmission

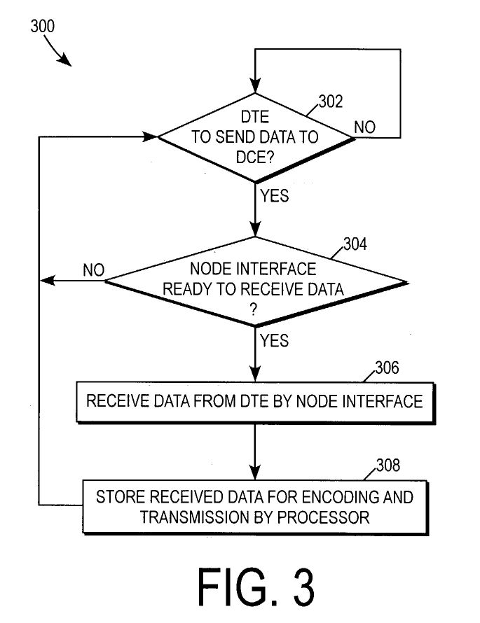

DTE 110 may transmit data to DCE 112 in any suitable manner for encoding and transmission onto transmission line 102. DTE 110 for one embodiment may transmit such data to DCE 112 in accordance with a flow diagram 300 as illustrated in FIG. 3.

For flow diagram 300 of FIG. 3, node interface 210 for block 302 identifies whether DTE 110 is to send data to DCE 112. Node interface 210 for one embodiment for block 302 may receive a request-to-send (RTS) signal from DTE 110.

When DTE 110 is to send data to DCE 112, node interface 210 for block 304 identifies whether node interface 210 is ready to receive data from DTE 110. Node interface 210 for one embodiment for block 304 may identify whether transmit buffer 212 is full and, if not, transmit a clear-to-send (CTS) signal to DTE 110.

When node interface 210 is ready to receive data from DTE 110, node interface 210 for block 306 receives data from DTE 110 and for block 308 stores the received data in transmit buffer 212 for encoding and transmission onto transmission line 102 by processor 230.

Although described in connection with transmitting data for encoding and transmission onto transmission line 102, DTE 110 for one embodiment may similarly transmit to DCE 112 commands, configuration data, program code or instructions, program code updates, and/or any other suitable data.

To encode data received from DTE 110 for transmission onto transmission line 102, DCE 112 processes such data a plurality of bits at a time in a parallel manner to help encode such data relatively faster. DCE 112 for one embodiment may encode data in accordance with a suitable communications protocol to define one or more frames of data where a frame is generally defined by a pattern of bits representing a start of frame flag, a fixed or variable number of bits of the data to be transmitted, and a pattern of bits representing an end of frame flag. DCE 112 for one embodiment may then transmit the frame(s) onto transmission line 102 in an outgoing bitstream. As DCE 122 receives the outgoing bitstream, DCE 122 may extract the data from the bitstream by identifying the start of frame flag and the end of frame flag of the transmitted frame(s). The start of frame flag and the end of frame flag for a frame may or may not have the same bit pattern. For one embodiment, an end of frame flag for one frame of data may also serve as a start of frame flag for a next frame of data.

Because the data to be transmitted may have a bit pattern that is the same as that for the start of frame flag, for the end of frame flag, or for any one or more other flags as defined by the communications protocol, DCE 112 for one embodiment may process such data a plurality of bits at a time to identify one or more bit patterns in the plurality of bits and, if a bit pattern is identified, to insert or stuff one or more bits of suitable value into the plurality of bits relative to the bit pattern. Inserting one or more bits into the plurality of bits in this manner helps DCE 122 identify only true flags in the outgoing bitstream. DCE 122 may identify and remove any stuffed bits as DCE 122 extracts data from the bitstream.

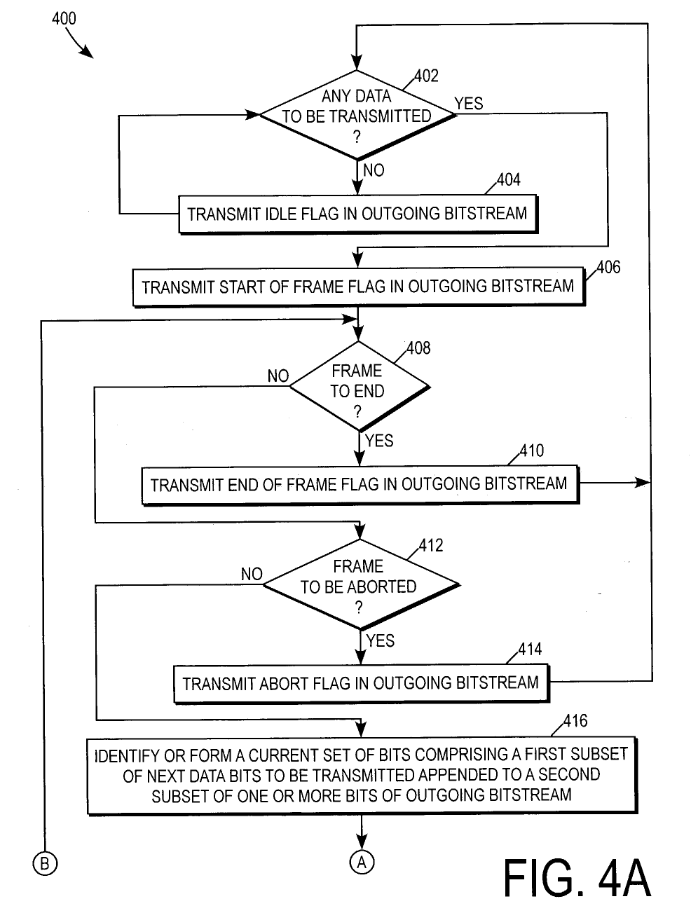

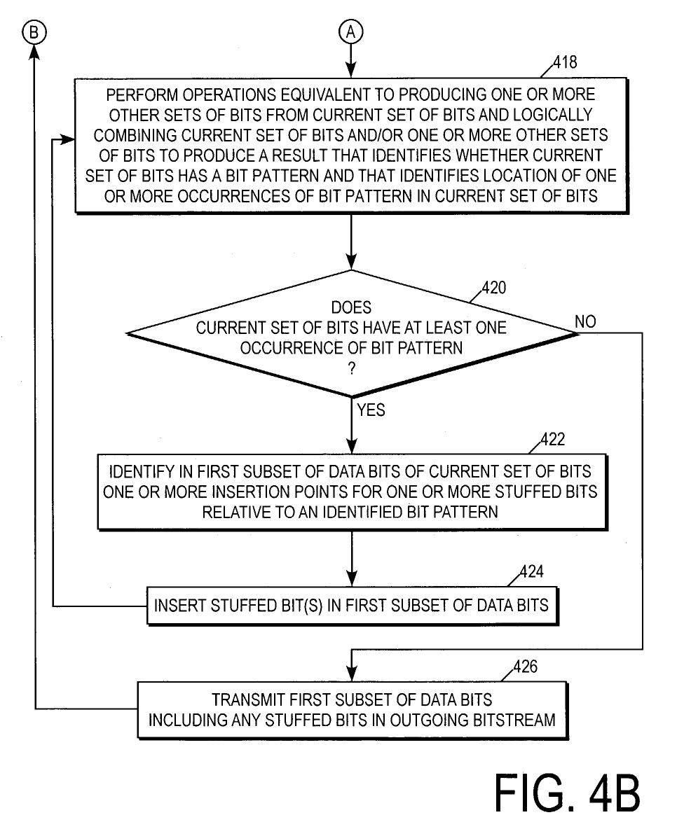

DCE 112 for one embodiment may encode and transmit data in accordance with a flow diagram 400 as illustrated in FIGS. 4A and 4B.

For flow diagram 400 of FIGS. 4A and 4B, processor 230 identifies for block 402 whether any data is to be transmitted onto transmission line 102. Processor 230 for one embodiment may identify for block 402 whether transmit buffer 212 of node interface 210 is storing any data received from DTE 110 for transmission onto transmission line 102. Processor 230 for one embodiment may also identify for block 402 whether any data stored in any other suitable location is to be transmitted onto transmission line 102. Examples of other suitable locations include registers 232, any cache memory of processor 230, non-volatile memory 242, and/or volatile memory 244. Although described in connection with transmitting data originating from DTE 110, processor 230 for one embodiment may also transmit data originating from DCE 112.

If no data is to be transmitted, processor 230 for one embodiment may optionally transmit for block 404 idle flags in a continuous, periodic, or sporadic manner in an outgoing bitstream on transmission line 102 to identify to DCE 122 that DCE 112 is still active. Processor 230 for one embodiment may transmit idle flags in the form of digital signals to line interface 220, and line interface 220 may convert the digital signals into corresponding analog signals for transmission onto transmission line 102.

If data is to be transmitted, processor 230 transmits for block 406 a start of frame flag for a new frame in the outgoing bitstream. The start of frame flag may have any suitable pattern of bits of any suitable length. For one embodiment, processor 230 may transmit a start of frame flag having a bit pattern of f consecutive bits of the same value, where f is an integer greater than one, preceded by a bit of a different value and followed by a bit of a different value. Where processor 230 encodes data in accordance with the HDLC or SDLC protocol, for example, processor 230 transmits a start of frame flag having the bit pattern 01111110. Processor 230 for one embodiment may transmit the start of frame flag in the form of digital signals to line interface 220, and line interface 220 may convert the digital signals into corresponding analog signals for transmission onto transmission line 102.

For one embodiment where the start of frame flag and the idle flag are the same, processor 230 may optionally skip block 406 provided processor 230 has already transmitted an idle flag for block 404.

Processor 230 identifies for block 408 whether the current frame is to end and identifies for block 412 whether the current frame is to be aborted.

If the current frame is not to end and is not to be aborted, processor 230 for block 416 identifies or forms a current set of bits comprising a first subset of a plurality of next data bits to be transmitted appended to a second subset of one or more bits of the outgoing bitstream. For one embodiment, the second subset of one or more bits may be a set of one or more of the current most significant bits of the outgoing bitstream. By identifying or forming a current set of bits in this manner, processor 230 may identify a bit pattern that extends from one or more prior data bits into the first subset of data bits of the current set of bits.

Processor 230 may identify or form a current set of bits for block 416 in any suitable manner. Processor 230 for one embodiment may identify a current set of bits for block 416 by identifying a first subset of data bits already logically and/or physically appended to a second subset of one or more bits of the outgoing bitstream in a suitable location such as, for example, registers 232, any cache memory of processor 230, non-volatile memory 242, and/or volatile memory 244.

Processor 230 for one embodiment may form a current set of bits for block 416 by requesting or retrieving a set of data bits from a suitable location, requesting or retrieving one or more bits of the outgoing bitstream from a suitable location, and appending the set of data bits with the one or more bits of the outgoing bitstream. Processor 230 for one embodiment may request or retrieve a set of data bits, for example, from transmit buffer 212 of node interface 210, registers 232, any cache memory of processor 230, non-volatile memory 242, and/or volatile memory 244. Processor 230 for one embodiment may request or retrieve one or more bits of the outgoing bitstream, for example, from registers 232, any cache memory of processor 230, non-volatile memory 242, and/or volatile memory 244.

The first subset of data bits, the second subset of bit(s), and therefore the current set of bits may have any suitable number of bits. The number of bits for the second subset of bit(s) for one embodiment may depend, for example, on one or more bit patterns to be identified to avoid transmitting data bits with one or more flag bit patterns. Where all bit pattern(s) to be identified are of an equal length of x bits, for example, the second subset of bits may have x or x−1 bit(s).

Processor 230 processes the current set of bits in parallel to identify whether the current set of bits has one or more occurrences of one or more bit patterns. Processor 230 may process the current set of bits to identify whether the current set of bits has any suitable one or more bit patterns of any suitable length. Processor 230 for one embodiment may process the current set of bits to identify whether the current set of bits has any suitable one or more portions of one or more flag bit patterns. In this manner, processor 230 may then insert one or more bits of suitable value relative to an identified flag bit pattern portion to avoid transmitting data bits with any corresponding flag bit patterns. Processor 230 for one embodiment may process the current set of bits to identify whether the current set of bits has a flag bit pattern portion common to more than one flag bit pattern.

For one embodiment where processor 230 is to avoid transmitting data bits with a start of frame flag bit pattern of 01111110, an end of frame flag bit pattern of 01111110, or an abort flag bit pattern of 11111111, processor 230 may identify or form for block 416 a set of bits with at least four of the most significant bits of the outgoing bitstream to allow processor 230 to identify a flag bit pattern portion of five consecutive bits having a value of one, that is 11111. Processor 230 may then avoid transmitting data bits with these flag bit patterns by inserting a bit having a value of zero after the most significant one bit in the identified flag bit pattern portion to produce 011111.

Processor 230 for another embodiment may avoid transmitting data bits with flag bit patterns having six consecutive zero bits, that is 000000, by identifying flag bit pattern portions of five consecutive zero bits, that is 00000, and inserting a bit having a value of one after the most significant zero bit in the identified flag bit pattern portion to produce 100000.

Processor 230 for one embodiment may perform operations on the current set of bits to produce a result that identifies whether the current set of bits has a bit pattern and that identifies a location of one or more occurrences of the bit pattern, if any, in the current set of bits. Processor 230 for one embodiment may perform operations on the current set of bits to produce a result that identifies a location of each occurrence of the bit pattern, if any, in the current set of bits.

Processor 230 may perform any suitable operations to produce a suitable result. As illustrated in FIG. 4B, processor 230 for one embodiment may perform for block 418 operations equivalent to producing one or more other sets of a plurality of bits from the current set of bits and logically combining the current set of bits and/or the produced one or more other sets of bits to produce a result.

Processor 230 for one embodiment for block 418 may actually produce one or more other sets of bits from the current set of bits and logically combine the current set of bits and/or the produced one or more other sets of bits to produce a result. Processor 230 may produce one or more other sets of bits from the current set of bits in any suitable manner. Processor 230 for one embodiment may shift and/or invert the current set of bits in any suitable manner to produce any suitable one or more other sets of bits. Processor 230 for one embodiment may use barrel shifter 234 to shift the current set of bits. Processor 230 for one embodiment may have a suitable architecture to shift bits using barrel shifter 234 while loading or storing operands, helping processor 230 to encode data to be transmitted relatively faster. How processor 230 produces one or more other sets of a plurality of bits from the current set of bits may depend, for example, on a bit pattern to be identified in the current set of bits.

Processor 230 may logically combine the current set of bits and/or the produced one or more other sets of bits in any suitable manner to produce any suitable result. Processor 230 for one embodiment may perform a logical AND operation, a logical OR operation, a logical NOR operation, and/or a logical NAND operation, for example, in logically combining the current set of bits and/or the produced one or more other sets of bits. How processor 230 logically combines the current set of bits and/or the produced one or more other sets of bits may depend, for example, on a bit pattern to be identified in the current set of bits.

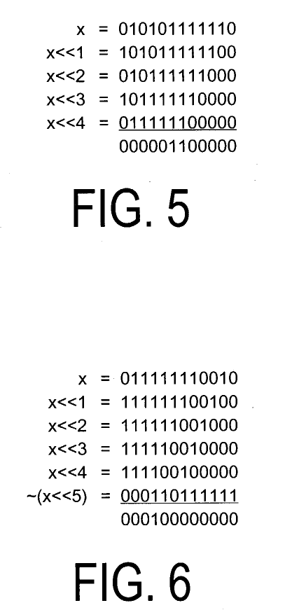

As one example, as illustrated in FIG. 5, processor 230 for one embodiment may identify whether at least one occurrence of the bit pattern 11111 is in the current set of bits 010101111110 by performing a logical AND operation on the current set of bits, a first other set of bits produced by shifting the current set of bits left by one bit position, a second other set of bits produced by shifting the current set of bits left by two bit positions, a third other set of bits produced by shifting the current set of bits left by three bit positions, and a fourth other set of bits produced by shifting the current set of bits left by four bit positions. The result of this logical AND operation is 000001100000. Processor 230 for another embodiment may invert the current set of bits and the first, second, third, and fourth sets of bits and perform a logical OR operation on the resulting sets of bits to produce a result of 111110011111.

As another example, as illustrated in FIG. 6, processor 230 for one embodiment may identify whether at least one occurrence of the bit pattern 111110 is in the current set of bits 011111110010 by performing a logical AND operation on the current set of bits, a first other set of bits produced by shifting the current set of bits left by one bit position, a second other set of bits produced by shifting the current set of bits left by two bit positions, a third other set of bits produced by shifting the current set of bits left by three bit positions, a fourth other set of bits produced by shifting the current set of bits left by four bit positions, and a fifth other set of bits produced by shifting the current set of bits left by five bit positions and inverting the shifted set of bits. The result of this logical AND operation is 000100000000. Processor 230 for another embodiment may invert the current set of bits and the first, second, third, and fourth other sets of bits, may produce a fifth other set of bits by shifting the current set of bits left by five bit positions, and may perform a logical OR operation on the resulting sets of bits to produce a result of 111011111111.

Processor 230 for another embodiment for block 418 may use the associative property of the logical AND or OR operator, for example, to help reduce the number of operations to produce a result. Processor 230 for one embodiment may produce one or more other sets of bits from the current set of bits, logically combine the current set of bits and/or the one or more other sets of bits produced from the current set of bits to produce a first intermediate result, produce one or more other sets of bits from the first intermediate result, and logically combine the first intermediate result and/or the one or more other sets of bits produced from the first intermediate result to produce a second intermediate or final result. Processor 230 may repeatedly produce one or more other sets of bits from a just prior intermediate result, and logically combine the just prior intermediate result and/or the one or more other sets of bits produced from the just prior intermediate result to produce another intermediate or final result. Processor 230 may also logically combine an intermediate result and/or one or more other sets of bits produced from the current set of bits to produce a final result. How processor 230 repeatedly produces one or more other sets of a plurality of bits from the current set of bits and any intermediate results and logically combines the current set of bits or any intermediate results with produced one or more other sets of bits may depend, for example, on a bit pattern to be identified in the current set of bits.

Referring to the example of FIG. 5, processor 230 for one embodiment may identify whether at least one occurrence of the bit pattern 11111 is in the current set of bits 010101111110 by performing the following operations using the logical AND operator:

a=x·(x<<1)

b=a·(a<<2)

c=b·(b<<1)

or by performing the following operations using the logical OR operator.

a=x′+(x<<1)′

b=a+(a<<2)

c=b+(b<<1)

Referring to the example of FIG. 6, processor 230 for one embodiment may identify whether at least one occurrence of the bit pattern 111110 is in the current set of bits 011111110010 by performing the following operations using the logical AND operator:

a=x·(x<<1)

b=a·(a<<2)

c=b·(b<<1)

d=c·(x<<5)′

or by performing the following operations using the logical OR operator.

a=x′+(x<<1)′

b=a+(a<<2)

c=b+(b<<1)

d=c+(x<<5)

Processor 230 for one embodiment may identify for block 420 whether at least one occurrence of a bit pattern is in the current set of bits based on the result from block 418. How the result from block 418 indicates whether at least one occurrence of a bit pattern is in a current set of bits depends, for example, on the operations performed for block 418.

Processor 230 for one embodiment may perform operations for block 418 such that the result will be equal to zero if a bit pattern is not in the current set of bits and will not be equal to zero if a bit pattern is in the current set of bits. Processor 230 for one embodiment may perform operations for block 418 such that all bits of the result have a value of one if a bit pattern is not in the current set of bits and at least one bit of the result has a value of zero if a bit pattern is in the current set of bits.

If at least one occurrence of a bit pattern is in the current set of bits, processor 230 for block 422 identifies in the first subset of data bits one or more insertion points for one or more stuffed bits relative to an identified bit pattern and inserts for block 424 the one or more stuffed bits at the identified one or more insertion points in the first subset of data bits. Processor 230 for one embodiment may identify for block 422 one or more insertion points relative to a bit of an identified bit pattern. Processor 230 for one embodiment may identify for block 422 an insertion point just after a most significant bit of a bit pattern. Where processor 230 identifies for block 420 more than one occurrence of a bit pattern, processor 230 for one embodiment may identify an insertion point relative to the bit pattern occupying the lesser significant bits of the current set of bits.

Processor 230 may identify any suitable one or more insertion points in any suitable manner and may insert one or more stuffed bits at the identified one or more insertion points in any suitable manner. Processor 230 for one embodiment may identify one or more insertion points for one or more stuffed bits based on the result from block 418. Processor 230 for one embodiment may perform operations for block 418 such that the result identifies a most significant bit position of an identified bit pattern in the current set of bits. Processor 230 may insert one or more stuffed bits of any suitable value at one or more insertion points relative to the most significant bit position of the identified bit pattern in the current set of bits. The value of a stuffed bit may depend, for example, on the one or more flag bit patterns processor 230 is to avoid transmitting as data bits.

Referring to the example of FIG. 5, the result 000001100000 identifies that the current set of bits 010101111110 has two occurrences of the bit pattern 11111 with the most significant bit of one bit pattern at bit position 6 of the current set of bits and the most significant bit of the other bit pattern at bit position 5 of the current set of bits. Processor 230 for one embodiment may identify an insertion point for a stuffed bit between bit positions 5 and 6 for this example because the most significant bit of the bit pattern occupying the lesser significant bits of the current set of bits is bit position 5. Processor 230 for one embodiment may insert a bit having a value of zero at this insertion point to avoid transmitting more than five consecutive data bits having a value of one and therefore avoid transmitting data bits with a start of frame flag bit pattern of 01111110, an end of frame flag bit pattern of 01111110, or an abort flag bit pattern of 11111111.

Processor 230 for one embodiment may repeat operations for blocks 418 and 420 to identify whether the current set of bits following the insertion of one or more stuffed bits in the current set of bits for block 422 has one or more occurrences of a bit pattern in the current set of bits. If so, processor 230 repeats operations for blocks 422 and 424 to insert one or more stuffed bits relative to an identified bit pattern. Processor 230 repeats operations for blocks 418, 420, 422, and 424 in this manner until processor 230 identifies for block 420 that the current set of bits does not have any occurrences of a bit pattern. Although described as performing operations for blocks 418-424 as a loop, processor 230 for another embodiment may perform operations for blocks 418-424 as an unrolled loop where, for example, the number of bits in the current set of bits is limited.

By processing a plurality of bits at a time for blocks 416-424, processor 230 may potentially encode data to be transmitted relatively faster as compared to encoding such data by examining one bit at a time. Also, processor 230 may perform operations for blocks 418-424 without having to perform any relatively slower memory accesses to read a current state of a state machine or to access any tables. As processor 230 may perform operations for blocks 418-424 without any tables or any state, except for the second subset of one or more bits which may be retained, for example, in registers 232 after processing a prior set of bits, no additional memory is required to store any tables or a state of a state machine.

As one example where processor 230 is to avoid transmitting data bits with a start of frame flag bit pattern of 01111110, an end of frame flag bit pattern of 01111110, or an abort flag bit pattern of 11111111 by identifying the bit pattern 11111 among data bits to be transmitted and inserting a zero bit following such identified bit patterns and where a current set of bits comprises a first subset of data bits that is 8 bits in length and a second subset of data bits that is 4 bits in length, processor 230 for one embodiment may execute instructions to perform operations for blocks 418-424 in accordance with the following C language program segment.

{ipoint=0xFFFF; /* initialize insertion point */

for (;;) {/* repeat until data does not have 11111 bit pattern */

ipoint &=data; /* ipoint=data=current set of bits zero-filled on the left */

ipoint &=ipoint<<1; /*=data & data<<1*/

ipoint &=ipoint<<2; /*=data & data<<1 & data<<2 & data<<3*

ipoint &=ipoint<<1; /*=data & data<<1 & data<<2 & data<<3 & data<<4*

if (!ipoint)/* if data does not have 11111 bit pattern */

return (data>>4); /* return first subset of data bits */

ipoint<<=1; /* shift to set insertion point to bit following 11111 bit pattern */

ipoint=˜((ipoint−1) & ipoint); /* create insertion point mask */

data+=data & ipoint;}}/* shift data above insertion point to insert zero bit */

When processor 230 identifies for block 420 that the current set of bits does not have any occurrences of a bit pattern, processor 230 for block 426 transmits in the outgoing bitstream the first subset of data bits of the current set of bits with any stuffed bits inserted in the first subset of data bits. Processor 230 for one embodiment may transmit the first subset of data bits with any stuffed bits inserted in the first subset of data bits in the form of digital signals to line interface 220, and line interface 220 converts the digital signals into corresponding analog signals for transmission onto transmission line 102.

Processor 230 for one embodiment may repeat operations for blocks 408-426 to receive and process more sets of data bits to be transmitted. As processor 230 identifies or forms a current set of bits for block 416 for one or more iterations of blocks 408-426 for the current frame, the number of bits for the first subset of data bits used for the current set of bits may be fixed or variable.

When processor 230 identifies for block 408 that the current frame is to end, processor 230 transmits for block 410 an end of frame flag for the current frame in the outgoing bitstream. Processor 230 may identify that a frame is to end because of any suitable condition. Processor 230 for one embodiment may identify that a frame is to end, for example, when all data bits to be transmitted have been transmitted or when a predetermined number of data bits have been transmitted in the frame.

The end of frame flag may have any suitable pattern of bits of any suitable length. For one embodiment, processor 230 may transmit an end of frame flag having a bit pattern of g consecutive bits of the same value, where g is an integer greater than one, preceded by a bit of a different value and followed by a bit of a different value. Where processor 230 encodes data in accordance with the HDLC or SDLC protocol, for example, processor 230 transmits an end of frame flag having the bit pattern 01111110. Processor 230 for one embodiment may transmit the end of frame flag in the form of digital signals to line interface 220, and line interface 220 may convert the digital signals into corresponding analog signals for transmission onto transmission line 102.

When processor 230 identifies for block 412 that the current frame is to be aborted, processor 230 transmits for block 414 an abort flag in the outgoing bitstream. Processor 230 may identify that a frame is to be aborted because of any suitable condition. Processor 230 for one embodiment may identify that a frame is to be aborted, for example, when a transmit underrun occurs in transmitting data bits from DTE 110 to DCE 112.

The abort flag may have any suitable pattern of bits of any suitable length. For one embodiment, processor 230 may transmit an abort flag having a bit pattern of h consecutive bits of the same value, where h is an integer greater than one. Where processor 230 encodes data in accordance with the HDLC or SDLC protocol, for example, processor 230 transmits an abort flag having the bit pattern 11111111. Processor 230 for one embodiment may transmit the abort flag in the form of digital signals to line interface 220, and line interface 220 may convert the digital signals into corresponding analog signals for transmission onto transmission line 102.

Processor 230 for one embodiment may then identify for block 402 whether more data is to be transmitted and, if so, transmit a new frame in the outgoing bitstream for blocks 406-426.

Processor 230 may perform operations for blocks 402-426 in any suitable order and may or may not overlap in time the performance of any suitable operation with any other suitable operation. Processor 230 for another embodiment may, for example, perform operations for blocks 412-414 prior to performing operations for blocks 408-410.

Data Reception and Decoding

DCE 112 for one embodiment may receive encoded data transmitted by DCE 122 onto transmission line 102 for decoding and transmission to DTE 110 by DCE 112. Although described in connection with receiving encoded data for decoding and transmission to DTE 110, DCE 112 for one embodiment may receive encoded data for decoding and use by DCE 112.

DCE 112 may receive encoded data from DCE 122 in any suitable manner. For one embodiment, line interface 220 may receive analog signals corresponding to bits in an incoming bitstream from transmission line 102. Line interface 220 converts the analog signals into corresponding digital signals for transmission to processor 230. Processor 230 receives the digital signals and processes the digital signals to identify the bits in the incoming bitstream. Processor 230 may store identified encoded bits in any suitable location, such as registers 232, any cache memory of processor 230, non-volatile memory 242, and/or volatile memory 244 for example, for decoding.

To decode the received encoded data in the incoming bitstream, DCE 112 processes such data a plurality of bits at a time in a parallel manner to help decode such data relatively faster. DCE 112 for one embodiment may decode data in accordance with a suitable communications protocol to identify one or more frames of data where a frame is generally defined by a pattern of bits representing a start of frame flag, a fixed or variable number of bits of the data to be transmitted, and a pattern of bits representing an end of frame flag. As DCE 112 receives the incoming bitstream, DCE 112 may extract the data from the bitstream by identifying the start of frame flag and the end of frame flag of the received frame(s). The start of frame flag and the end of frame flag for a frame may or may not have the same bit pattern. For one embodiment, an end of frame flag for one frame of data may also serve as a start of frame flag for a next frame of data.

The encoded data may have one or more stuffed bits of suitable value to help DCE 112 avoid receiving data having a bit pattern for the start of frame flag, for the end of frame flag, or for any one or more other flags as defined by the communications protocol. DCE 112 for one embodiment may process such data a plurality of bits at a time to identify one or more bit patterns in the plurality of bits and, if a bit pattern is identified, to identify whether a flag has been received or whether one or more stuffed bits are to be removed in extracting data from the plurality of bits.

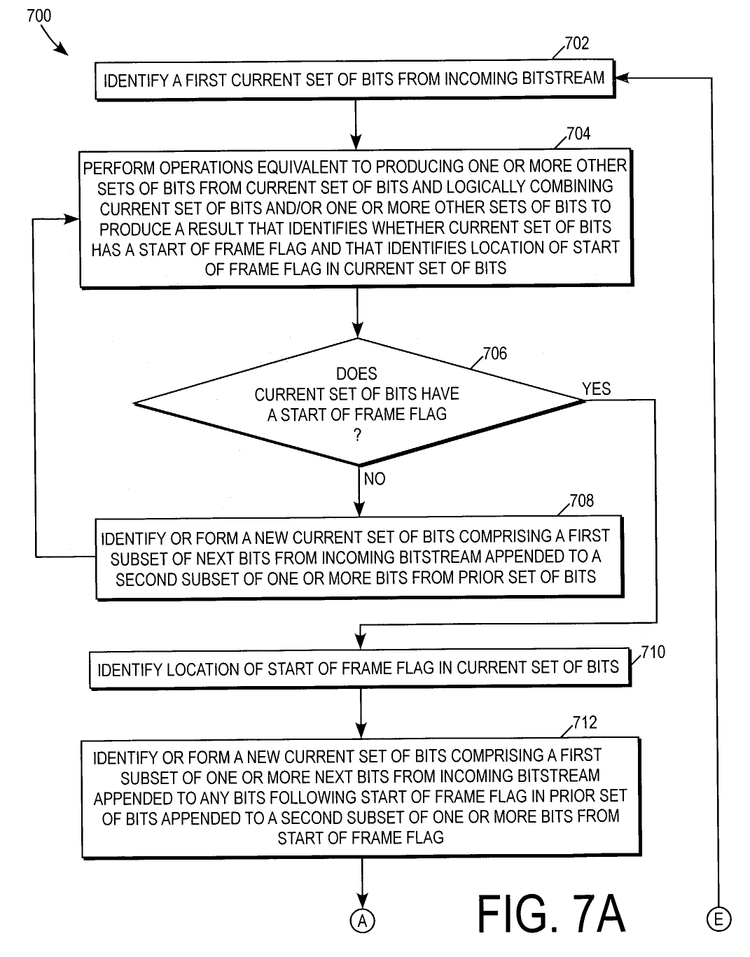

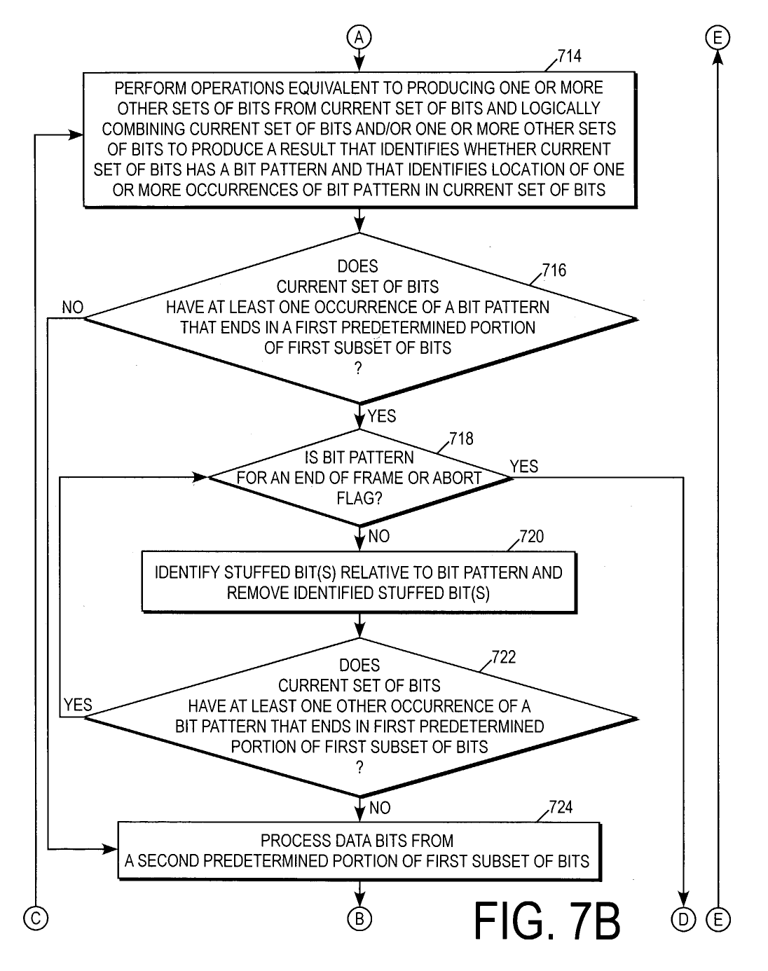

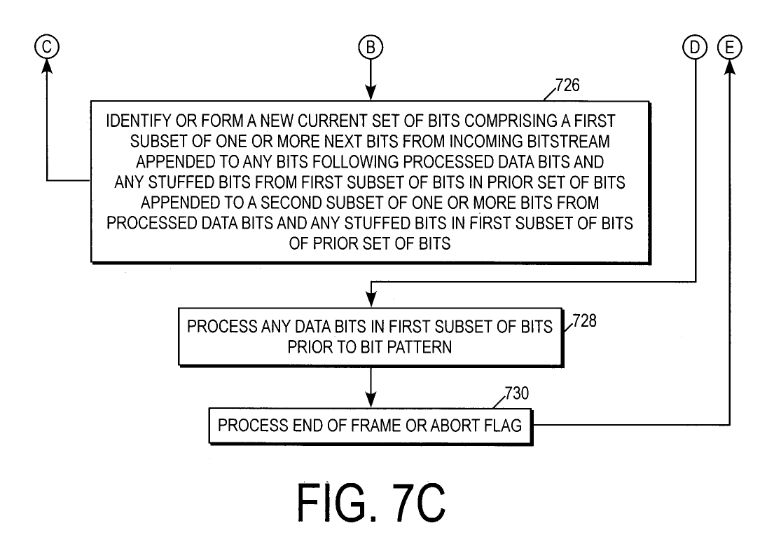

DCE 112 for one embodiment may decode data in accordance with a flow diagram 700 as illustrated in FIGS. 7A, 7B, and 7C.

For flow diagram 700 of FIGS. 7A, 7B, and 7C, processor 230 identifies for block 702 a first current set of a plurality of bits from the incoming bitstream. Processor 230 may identify for block 702 any suitable number of bits from the incoming bitstream in any suitable manner from any suitable location. Processor 230 for one embodiment for block 702 may request or retrieve bits from registers 232, any cache memory of processor 230, non-volatile memory 242, and/or volatile memory 244.

Processor 230 processes the current set of bits in parallel to identify whether the current set of bits has a bit pattern for a start of frame flag. The start of frame flag may have any suitable pattern of bits of any suitable length. For one embodiment, processor 230 may process the current set of bits to identify whether the current set of bits has a start of frame flag having a bit pattern of f consecutive bits of the same value, where f is an integer greater than one, preceded by a bit of a different value and followed by a bit of a different value. Where the received data is encoded in accordance with the HDLC or SDLC protocol, for example, processor 230 may process the current set of bits to identify whether the current set of bits has a start of frame flag having the bit pattern 01111110.

Processor 230 for one embodiment may perform operations on the current set of bits to produce a result that identifies whether the current set of bits has a bit pattern for a start of frame flag and that identifies a location of the bit pattern, if any, in the current set of bits.

Processor 230 may perform any suitable operations to produce a suitable result. As illustrated in FIG. 7A, processor 230 for one embodiment may perform for block 704 operations equivalent to producing one or more other sets of a plurality of bits from the current set of bits and logically combining the current set of bits and/or the produced one or more other sets of bits to produce a result.

Processor 230 for one embodiment for block 704 may actually produce one or more other sets of bits from the current set of bits and logically combine the current set of bits and/or the produced one or more other sets of bits to produce a result. Processor 230 may produce one or more other sets of bits from the current set of bits in any suitable manner. Processor 230 for one embodiment may shift and/or invert the current set of bits in any suitable manner to produce any suitable one or more other sets of bits. Processor 230 for one embodiment may use barrel shifter 234 to shift the current set of bits. Processor 230 for one embodiment may have a suitable architecture to shift bits using barrel shifter 234 while loading or storing operands, helping processor 230 to decode received encoded data relatively faster. How processor 230 produces one or more other sets of a plurality of bits from the current set of bits may depend, for example, on the bit pattern for a start of frame flag to be identified in the current set of bits.

Processor 230 may logically combine the current set of bits and/or the produced one or more other sets of bits in any suitable manner to produce any suitable result. Processor 230 for one embodiment may perform a logical AND operation, a logical OR operation, a logical NOR operation, and/or a logical NAND operation, for example, in logically combining the current set of bits and/or the produced one or more other sets of bits. How processor 230 logically combines the current set of bits and/or the produced one or more other sets of bits may depend, for example, on the bit pattern for a start of frame flag to be identified in the current set of bits.

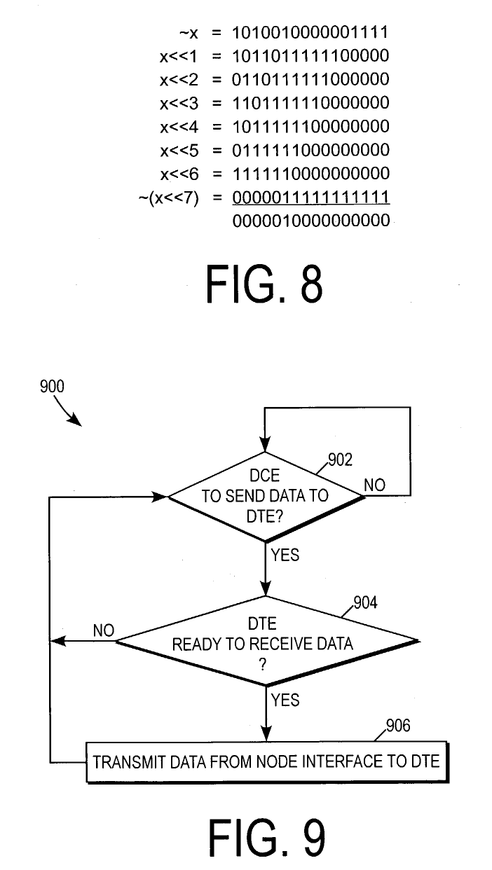

As one example, as illustrated in FIG. 8, processor 230 for one embodiment may identify a start of frame flag having the bit pattern 01111110 in the current set of bits 01011011111110000 by performing a logical AND operation on a first other set of bits produced by inverting the current set of bits, a second other set of bits produced by shifting the current set of bits left by one bit position, a third other set of bits produced by shifting the current set of bits left by two bit positions, a fourth other set of bits produced by shifting the current set of bits left by three bit positions, a fifth other set of bits produced by shifting the current set of bits left by four bit positions, a sixth other set of bits produced by shifting the current set of bits left by five bit positions, a seventh other set of bits produced by shifting the current set of bits left by six bit positions, and an eighth other set of bits produced by shifting the current set of bits left by seven bit positions and inverting the shifted set of bits. The result of this logical AND operation is 0000010000000000.

Processor 230 for another embodiment may invert the second, third, fourth, fifth, sixth, and seventh other sets of bits, may produce an eighth other set of bits by shifting the current set of bits left by seven bit positions, and may perform a logical OR operation on the current set of bits and the resulting second, third, fourth, fifth, sixth, seventh, and eighth other sets of bits to produce a result of 1111101111111111.

Processor 230 for another embodiment for block 704 may use the associative property of the logical AND or OR operator, for example, to help reduce the number of operations to produce a result. Processor 230 for one embodiment may produce one or more other sets of bits from the current set of bits, logically combine the current set of bits and/or the one or more other sets of bits produced from the current set of bits to produce a first intermediate result, produce one or more other sets of bits from the first intermediate result, and logically combine the first intermediate result and/or the one or more other sets of bits produced from the first intermediate result to produce a second intermediate or final result. Processor 230 may repeatedly produce one or more other sets of bits from a just prior intermediate result, and logically combine the just prior intermediate result and/or the one or more other sets of bits produced from the just prior intermediate result to produce another intermediate or final result. Processor 230 may also logically combine an intermediate result and/or one or more other sets of bits produced from the current set of bits to produce a final result. How processor 230 repeatedly produces one or more other sets of a plurality of bits from the current set of bits and any intermediate results and logically combines the current set of bits or any intermediate results with produced one or more other sets of bits may depend, for example, on a bit pattern to be identified in the current set of bits.

For block 706, processor 230 for one embodiment may identify whether the current set of bits has a bit pattern for a start of frame flag based on the result from block 704. How the result from block 704 indicates whether a bit pattern for a start of frame flag is in a current set of bits depends, for example, on the operations performed for block 704.

Processor 230 for one embodiment may perform operations for block 704 such that the result will be equal to zero if a bit pattern for a start of frame flag is not in the current set of bits and will not be equal to zero if a bit pattern for a start of frame flag is in the current set of bits. Processor 230 for one embodiment may perform operations for block 704 such that all bits of the result have a value of one if a bit pattern for a start of frame flag is not in the current set of bits and at least one bit of the result has a value of zero if a bit pattern for a start of frame flag is in the current set of bits.

If a bit pattern for a start of frame flag is not in the current set of bits, processor 230 for block 708 identifies or forms a new current set of bits comprising a first subset of a plurality of next bits from the incoming bitstream appended to a second subset of one or more bits from the just prior set of bits processed for blocks 704 and 706. For one embodiment, the second subset of one or more bits may be a set of one or more of the most significant bits for the just prior processed set of bits. By identifying or forming a current set of bits in this manner, processor 230 may identify a bit pattern for a start of frame flag that extends from one or more prior bits in the incoming bitstream into the first subset of next bits from the incoming bitstream.

Processor 230 may identify or form a new current set of bits for block 708 in any suitable manner. Processor 230 for one embodiment may identify a new current set of bits for block 708 by identifying a first subset of next bits from the incoming bitstream already logically and/or physically appended to a second subset of one or more bits from the just prior processed set of bits in a suitable location such as, for example, registers 232, any cache memory of processor 230, non-volatile memory 242, and/or volatile memory 244.

Processor 230 for one embodiment may form a current set of bits for block 708 by requesting or retrieving a set of next bits from the incoming bitstream from a suitable location, requesting or retrieving one or more bits from the just prior processed set of bits from a suitable location, and appending the set of next bits from the incoming bitstream with the one or more bits from the just prior processed set of bits. Processor 230 for one embodiment may request or retrieve a set of next bits from the incoming bitstream, for example, from registers 232, any cache memory of processor 230, non-volatile memory 242, and/or volatile memory 244. Processor 230 for one embodiment may request or retrieve one or more bits from the just prior processed set of bits, for example, from registers 232, any cache memory of processor 230, non-volatile memory 242, and/or volatile memory 244.

The first subset of bits, the second subset of bit(s), and therefore the current set of bits may have any suitable number of bits. The number of bits for the second subset of bit(s) for one embodiment may depend, for example, on the bit pattern for a start of frame flag to be identified. Where the bit pattern for a start of frame flag has a length of x bits, for example, the second subset of bits may have x or x−1 bit(s).

Processor 230 then repeats operations for blocks 704 and 706 to identify whether the new current set of bits identified or formed for block 708 has a bit pattern for a start of frame flag. If a bit pattern for a start of frame flag is not in the current set of bits as identified for block 706, processor 230 identifies or forms a new set of current bits for block 708. Processor 230 repeats operations for blocks 704, 706, and 708 in this manner until processor 230 for block 706 identifies a bit pattern for a start of frame flag in the current set of bits.

When processor 230 for block 706 identifies a bit pattern for a start of frame flag in the current set of bits, processor 230 for block 710 identifies the location of the identified start of frame flag in the current set of bits. Processor 230 for one embodiment may identify for block 710 an end bit position of the start of frame flag in the current set of bits. Processor 230 for one embodiment may identify for block 710 the bit position of a most significant bit of the start of frame flag in the current set of bits.

Processor 230 may identify an end bit position of a start of frame flag in any suitable manner. Processor 230 for one embodiment may identify an end bit position of a start of frame flag based on the result from block 704. Processor 230 for one embodiment may perform operations for block 704 such that the result identifies a most significant bit position of a start of frame flag in the current set of bits with a bit of a predetermined value in the most significant bit position of the start of frame flag in the current set of bits. Processor 230 for one embodiment may then identify the most significant bit position of a bit having a predetermined value in the result from block 704 to identify an end bit position of the start of frame flag.

Processor 230 for one embodiment may execute a suitable instruction available in the instruction set for processor 230 to help identify a bit position of a bit having a predetermined value in the result from block 704. Where processor 230 has an Intel® IA-32 architecture designed by Intel® Corporation of Santa Clara, Calif., for example, processor 230 may execute the Bit Scan Forward (BSF) or the Bit Scan Reverse (BSR) instruction. Where processor 230 has a TMS320 DSP architecture designed by Texas Instruments® Incorporated of Dallas, Tex., processor 230 may execute the NORM instruction. Processor 230 for another embodiment may execute suitable instructions in a loop to examine possible bit positions for a bit having a predetermined value in the result from block 704. Processor 230 for another embodiment may perform a suitable binary search algorithm to identify a bit position of a bit having a predetermined value in the result from block 704.

For block 712, processor 230 identifies or forms a new current set of bits comprising a first subset of one or more next bits from the incoming bitstream appended to any bits following the start of frame flag in the just prior processed set of bits. The new current set of bits may optionally comprise a second subset of one or more of the most significant bits of the start of frame flag in the just prior processed set of bits appended to any bits of the first subset following the start of frame flag in the just prior processed set of bits. Processor 230 for one embodiment may identify or form a new current set of bits for block 712 similarly as for block 708. The first subset of bits, any second subset of bit(s), and therefore the current set of bits may have any suitable number of bits.

Processor 230 processes the current set of bits in parallel to identify whether the current set of bits has one or more occurrences of one or more bit patterns. Processor 230 may process the current set of bits to identify whether the current set of bits has any suitable one or more bit patterns of any suitable length. Processor 230 for one embodiment may process the current set of bits to identify whether the current set of bits has any suitable one or more portions of one or more flag bit patterns. In this manner, processor 230 may then examine one or more other bits relative to an identified bit pattern to identify whether the identified bit pattern forms a portion of a flag or comprises data bits. Processor 230 for one embodiment may process the current set of bits to identify whether the current set of bits has a flag bit pattern portion common to more than one flag bit pattern.

For one embodiment where processor 230 is to identify a start of frame flag bit pattern of 01111110, an end of frame flag bit pattern of 01111110, and/or an abort flag bit pattern of 11111111 among data bits in an incoming bitstream, processor 230 may identify or form for block 712 a current set of bits to identify a flag bit pattern portion of five consecutive bits having a value of one, that is 11111.

Processor 230 may then identify whether an identified bit pattern forms a portion of a flag or comprises data bits by examining the bit after the most significant bit in the identified bit pattern. If the bit after the most significant bit in the identified bit pattern has a value of zero, processor 230 identifies the identified bit pattern as comprising data with a stuffed zero bit and removes the stuffed zero bit. If the bit after the most significant bit in the identified bit pattern has a value of one, processor 230 identifies the identified bit pattern as forming a portion of a flag and identifies the flag either as an end of frame flag or as an abort flag by examining the bit following the bit following the identified bit pattern.

Processor 230 for one embodiment may perform operations on the current set of bits to produce a result that identifies whether the current set of bits has a bit pattern and that identifies a location of one or more occurrences of the bit pattern, if any, in the current set of bits. Processor 230 for one embodiment may perform operations on the current set of bits to produce a result that identifies a location of each occurrence of the bit pattern, if any, in the current set of bits.

Processor 230 may perform any suitable operations to produce a suitable result. As illustrated in FIG. 7B, processor 230 for one embodiment may perform for block 714 operations equivalent to producing one or more other sets of a plurality of bits from the current set of bits and logically combining the current set of bits and/or the produced one or more other sets of bits to produce a result. Processor 230 for one embodiment may perform operations for block 714 similarly as processor 230 performs operations for block 418 of FIG. 4B.

For block 716, processor 230 for one embodiment may identify whether the current set of bits has at least one occurrence of a bit pattern that ends in a first predetermined portion of the first subset of bits based on the result from block 714. Processor 230 may identify whether a bit pattern in the current set of bits ends in any suitable portion of the first subset of bits. The length of the first predetermined portion may depend, for example, on the length of a second predetermined portion of the first subset of bits from which processor 230 is to extract data bits.

As one example where a current set of bits comprises a first subset of bits that is 12 bits in length, where processor 230 is to extract 8 data bits from the first subset of bits, and where the current set of bits are encoded in accordance with a communications protocol defining that data bits are to be encoded with a stuffed zero bit following five consecutive one bits to avoid transmitting data bits with a start of frame flag bit pattern of 01111110, an end of frame flag bit pattern of 01111110, or an abort flag bit pattern of 11111111, processor 230 for one embodiment may identify whether the current set of bits has a bit pattern that ends in the 8 least significant bit positions of the first subset of bits.

How the result from block 714 indicates whether at least one occurrence of a bit pattern is in a current set of bits and ends in a first predetermined portion of the first subset of bits of the current set of bits depends, for example, on the operations performed for block 714. Processor 230 for one embodiment may perform operations for block 714 such that the result identifies an end bit position, such as the most significant bit position for example, of a bit pattern in the current set of bits with a bit of a predetermined value in the corresponding end bit position of the bit pattern in the current set of bits. Processor 230 for one embodiment may then identify the bit position of a bit having a predetermined value in the result from block 714 to identify where a bit pattern ends in the current set of bits.

If the current set of bits does not have at least one occurrence of a bit pattern that ends in a first predetermined portion of the first subset of bits, processor 230 for one embodiment may then process for block 724 data bits in a second predetermined portion of the first subset of bits of the current set of bits. Processor 230 may process data bits in any suitable portion of the first subset of bits in any suitable manner. The second predetermined portion of the first subset of bits of a current set of bits may or may not be the same as the first predetermined portion of the first subset of bits of the current set of bits. Processor 230 for one embodiment may transmit data bits in the second predetermined portion of the first subset of bits to node interface 210 to store the data bits in receive buffer 214 for transmission to DTE 110.

If the current set of bits has at least one occurrence of a bit pattern that ends in a first predetermined portion of the first subset of bits, processor 230 for one embodiment may then identify for block 718 whether one occurrence of a bit pattern forms a portion of an end of frame or abort flag or comprises data bits. Processor 230 may identify whether a bit pattern forms a portion of an end of frame or abort flag or comprises data bits in any suitable manner. Processor 230 for one embodiment may examine in the current set of bits one or more bits relative to an identified bit pattern to identify whether any stuffed bits were inserted relative to the bit pattern. If so, the bit pattern comprises data bits. If not, the bit pattern forms a portion of an end of frame or abort flag.

As one example where the current set of bits are encoded in accordance with a communications protocol defining that data bits are to be encoded with a stuffed zero bit following a bit pattern of five consecutive one bits to avoid transmitting data bits with a start of frame flag bit pattern of 01111110, an end of frame flag bit pattern of 01111110, or an abort flag bit pattern of 11111111, processor 230 for one embodiment may identify whether the current set of bits comprises a zero bit following an identified bit pattern of five consecutive ones.

If the identified bit pattern comprises data bits, processor 230 identifies for block 720 one or more stuffed bits relative to the identified bit pattern and removes the identified stuffed bit(s). Processor 230 may identify and remove one or more stuffed bits in any suitable manner. Processor 230 for one embodiment may identify for block 720 one or more stuffed bits relative to a bit of the identified bit pattern. Processor 230 for one embodiment may identify for block 720 a stuffed bit just after a most significant bit of a bit pattern. As processor 230 removes one or more stuffed bits from the second predetermined portion of the first subset of bits of the current set of bits, processor 230 for one embodiment may shift any remaining bits in the current set of bits following one or more removed stuffed bits such that one or more bits, if any, following the second predetermined portion of the first subset of bits are shifted into the second predetermined portion of the first subset of bits.

For block 722, processor 230 identifies whether the current set of bits has at least one other occurrence of a bit pattern that ends in the first predetermined portion of the first subset of bits. As processor 230 for one embodiment may shift bits in the current set of bits for block 720, an occurrence of a bit pattern in the current set of bits that initially did not end in the first predetermined portion of the first subset of bits may be shifted into the first predetermined portion of the first subset of bits following the removal of one or more stuffed bits for block 720.

If processor 230 identifies for block 722 that the current set of bits has at least one other occurrence of a bit pattern that ends in the first predetermined portion of the first subset of bits, processor 230 for one embodiment may repeat operations for blocks 718, 720, and 722 until processor 230 identifies for block 718 that an identified bit pattern forms a portion of an end of frame or abort flag or until processor 230 identifies for block 722 that the current set of bits does not have any more occurrences of a bit pattern that ends in the first predetermined portion of the first subset of bits. If processor 230 identifies for block 716 that the current set of bits has more than one occurrence of a bit pattern that ends in a first predetermined portion of the first subset of bits, processor 230 for one embodiment may perform operations for blocks 718, 720, and 722 starting with the bit pattern occupying the lesser significant bit positions, and then with the bit pattern occupying the next lesser significant bit positions, etc. Although described as performing operations for blocks 718-722 as a loop, processor 230 for another embodiment may perform operations for blocks 718-722 as an unrolled loop where, for example, the number of bits in the current set of bits is limited.

When processor 230 identifies for block 722 that the current set of bits does not have any more bit patterns that end in the first predetermined portion of the first subset of bits, processor 230 processes for block 724 data bits in the second predetermined portion of the first subset of bits of the current set of bits.

By processing a plurality of bits at a time for blocks 712-724, processor 230 may potentially decode received encoded data relatively faster as compared to decoding such data by examining one bit at a time. Also, processor 230 may perform operations for blocks 714-724 without having to perform any relatively slower memory accesses to read a current state of a state machine or to access any tables. As processor 230 may perform operations for blocks 714-724 without any tables or any state, except for the second subset of one or more bits which may be retained, for example, in registers 232 after processing a prior set of bits, no additional memory is required to store any tables or a state of a state machine.

As one example where processor 230 is to decode data encoded with a stuffed zero bit following the bit pattern 11111 to avoid transmitting data bits with a start of frame flag bit pattern of 01111110, an end of frame flag bit pattern of 01111110, or an abort flag bit pattern of 11111111; where a current set of bits comprises a first subset of bits that is 12 bits in length and a second subset of bits that is 4 bits in length; and where processor 230 is to extract 8 data bits from the first subset of bits, processor 230 for one embodiment may execute instructions to perform operations for blocks 714-724 in accordance with the following C language program segment.

{bits=(UINT16) bitstream; /* get current set of bits from incoming bitstream */

stuffedbits=bits & (bits<<1); /* bits & bits<<1*/

stuffedbits &=stuffedbits<<2; /*=bits & bits<<1 & bits<<2 & bits<<3*/

stuffedbits &=stuffedbits<<1; /*=bits & bits<<1 & bits<<2 & bits<<3 & bits<<4*/

if (stuffedbits & 0x0FF0) {/* if bits have 11111 bit pattern ending in 8 bit portion */

stuffedbits<<=1; /* shift to examine bit following 11111 bit pattern */

if (stuffedbits & bits)/* if have 6 bits in a row */

return FrameEnd(bitstream); /* end of frame or abort */

lomask=(stuffedbits−1) & ˜stuffedbits; /* create mask */

bits=((lomask & bits)+bits)>>1; /* use mask to remove stuffed zero bit */

stuffedbits−=(lomask+1); /* remove lowest stuffed zero bit marker */

stuffedbits>>=1; /* account for removal of a bit in bits */

stuffedbits &=0x1FE0; /* constrain stuffedbits to 8 bit portion */

if (stuffedbits) {/* if 11111 bit pattern ends in 8 bit portion */

lomask=stuffedbits−1; /* create mask */

bits=((lomask & bits)+bits)>>1;}}/* remove stuffed zero bit */

return (bits>>4) & 0x00FF}/* return extracted 8 data bits */

For block 726, processor 230 identifies or forms a new current set of bits comprising (1) a first subset of one or more next bits from the incoming bitstream appended to any bits following (a) the data bits processed for block 724 and (b) any stuffed bits identified for block 720 from the first subset of bits of the just prior set of bits prior to removal of any stuffed bits appended to (2) a second subset of one or more bits from (a) the data bits processed for block 724 and (b) any stuffed bits identified for block 720 from the first subset of bits of the just prior set of bits prior to removal of any stuffed bits. For one embodiment, the second subset of one or more bits may be a set of one or more of the most significant bits from (a) the data bits processed for block 724 and (b) any stuffed bits identified for block 720 from the first subset of bits of the just prior set of bits prior to removal of any stuffed bits.

Where the first subset of bits of the just prior set of bits did not have any stuffed bits identified for block 720, processor 230 for one embodiment may identify or form for block 726 a new current set of bits comprising a first subset of one or more next bits from the incoming bitstream appended to any bits following the second predetermined portion of bits of the first subset of bits of the just prior set of bits appended to a second subset of one or more of the most significant bits from the second predetermined portion of bits of the first subset of bits of the just prior set of bits.

Processor 230 for one embodiment may identify or form a new current set of bits for block 726 similarly as for block 708 and/or block 712. The first subset of bits, the second subset of bit(s), and therefore the new current set of bits may have any suitable number of bits.

Processor 230 for one embodiment may then repeat operations for blocks 714-726 to identify whether the new current set of bits has a bit pattern that ends in a first predetermined portion of the first subset of bits and that forms a portion of an end of frame or abort flag and, if not, to extract data bits from the new current set of bits. Processor 230 for one embodiment may repeat operations for blocks 714-726 in this manner until processor 230 identifies for block 718 that a new current set of bits has a bit pattern that ends in a first predetermined portion of the first subset of bits and that forms a portion of an end of frame or abort flag.

When processor 230 identifies a bit pattern that ends in a first predetermined portion of the first subset of bits of the current set of bits and that forms a portion of an end of frame or abort flag, processor 230 for one embodiment may process for block 728 any data bits in the first subset of bits prior to the bit pattern forming a portion of an end of frame or abort flag. Processor 230 for one embodiment may process such data bits for block 728 similarly as for block 724. Processor 230 may then process for block 730 the end of frame or abort flag. Processor 230 may process the end of frame or abort flag in any suitable manner.

Processor 230 for one embodiment may then repeat operations for blocks 702-730 to identify a new frame of data and extract data bits from the new frame.

Processor 230 may perform operations for blocks 702-730 in any suitable order and may or may not overlap in time the performance of any suitable operation with any other suitable operation. Processor 230 for another embodiment may, for example, perform operations for block 718 to identify whether any identified bit pattern in a current set of bits is for an end of frame or abort flag prior to performing any operations for blocks 720 and 722. As another example, processor 230 for another embodiment may perform operations for block 714, 716, and 718 to identify an end of frame or abort flag in a current set of bits separate from performing operations for blocks 714, 716, 720, and 722 to identify and remove any stuffed bits in the current set of bits.

DCE 112 may transmit to DTE 110 data received from transmission line 102 and decoded by DCE 112 in any suitable manner. DCE 112 for one embodiment may transmit such data to DTE 110 in accordance with a flow diagram 900 as illustrated in FIG. 9.

For flow diagram 900 of FIG. 9, node interface 210 for block 902 identifies whether DCE 112 is to send data to DTE 110. Node interface 210 for one embodiment for block 902 may identify whether any data to be transmitted to DTE 110 is stored in receive buffer 214. Node interface 210 for one embodiment may transmit a request-to-send (RTS) signal to DTE 110 when node interface 210 is to transmit data to DTE 110.

When DCE 112 is to send data to DTE 110, node interface 210 for block 904-identifies whether DTE 110 is ready to receive data from DCE 112. Node interface 210 for one embodiment for block 904 may receive a clear-to-send (CTS) signal from DTE 110 when DTE 110 is ready to receive data.

When DTE 110 is ready to receive data from DCE 112, node interface 210 for block 906 transmits data from DCE 112 to DTE 110. Node interface 210 for one embodiment may transmit data stored in receive buffer 214 to DTE 110.

Although described in connection with transmitting data received from transmission line 102 and decoded by DCE 112, DCE 112 for one embodiment may similarly transmit to DTE 110 commands, configuration data, and/or any other suitable data.

In the foregoing description, one or more embodiments of the present invention have been described. It will, however, be evident that various modifications and changes may be made thereto without departing from the broader spirit or scope of the present invention as defined in the appended claims. The specification and drawings are, accordingly, to be regarded in an illustrative rather than a restrictive sense.

What is claimed is:

1. A method comprising:
(a) processing a set of a plurality of bits to identify whether the set of bits has a bit pattern,
wherein the set of bits comprises a first subset of a plurality of bits to be transmitted in an outgoing bitstream appended to a second subset of one or more bits of the outgoing bitstream, and
wherein the processing comprises performing operations on the set of bits to produce a result that identifies whether the set of bits has the bit pattern and that identifies a location of the bit pattern in the set of bits;
(b) if the set of bits has the bit pattern, inserting one or more bits in the first subset of bits relative to the bit pattern; and
(c) transmitting in the outgoing bitstream the first subset of bits with any inserted bits at a speed of at least 14.4 kbps.

2. The method of claim 1, wherein the processing comprises performing operations equivalent to producing one or more other sets of bits from the set of bits and logically combining the set of bits and/or the one or more other sets of bits to produce the result.

3. The method of claim 2, wherein the processing comprises producing one or more other sets of bits from the set of bits and logically combining the set of bits and/or the one or more other sets of bits to produce the result.

4. The method of claim 2, wherein the processing comprises:
(i) producing one or more other sets of bits from the set of bits,
(ii) logically combining the set of bits and/or the one or more other sets of bits produced from the set of bits to produce a first intermediate result,
(iii) producing one or more other sets of bits from the first intermediate result, and
(iv) logically combining the first intermediate result and/or the one or more other sets of bits produced from the first intermediate result to produce a second intermediate result.

5. The method of claim 2, wherein the producing one or more other sets of bits from the set of bits comprises shifting and/or inverting the set of bits.

6. The method of claim 2, wherein the logically combining the set of bits and/or the one or more other sets of bits comprises performing a logical AND operation on the set of bits and/or the one or more other sets of bits.

7. An apparatus comprising:
(a) a first interface to receive data from data terminal equipment;
(b) a processor to process a set of a plurality of bits of the received data to identify whether the set of bits has a bit pattern,
wherein the set of bits comprises a first subset of a plurality of bits to be transmitted in an outgoing bitstream appended to a second subset of one or more bits of the outgoing bitstream,
wherein the processor is to perform operations on the set of bits to produce a result that identifies whether the set of bits has the bit pattern and that identifies a location of the bit pattern in the set of bits, and
wherein the processor is to insert one or more bits in the first subset of bits relative to the bit pattern if the set of bits has the bit pattern; and
(c) a second interface to transmit the outgoing bitstream at a speed of at least 14.4 kbps.

8. The apparatus of claim 7, wherein the processor is to perform operations equivalent to producing one or more other sets of bits from the set of bits and logically combine the set of bits and/or the one or more other sets of bits to produce the result.

9. The apparatus of claim 8, wherein the processor is to produce one or more other sets of bits from the set of bits and logically combine the set of bits and/or the one or more other sets of bits to produce the result.

10. The apparatus of claim 8, wherein the processor is to produce one or more other sets of bits from the set of bits, logically combine the set of bits and/or the one or more other sets of bits produced from the set of bits to produce a first intermediate result, produce one or more other sets of bits from the first intermediate result, and logically combine the first intermediate result and/or the one or more other sets of bits produced from the first intermediate result to produce a second intermediate result.

11. The apparatus of claim 8, wherein the processor is to produce one or more other sets of bits from the set of bits by shifting and/or inverting the set of bits.

12. The apparatus of claim 8, wherein the processor is to logically combine the set of bits and/or the one or more other sets of bits by performing a logical AND operation on the set of bits and/or the one or more other sets of bits.

13. An apparatus comprising:
(a) means for processing a set of a plurality of bits to identify whether the set of bits has a bit pattern,
wherein the set of bits comprises a first subset of a plurality of bits to be transmitted in an outgoing bitstream appended to a second subset of one or more bits of the outgoing bitstream, and
wherein the means for processing comprises means for performing operations on the set of bits to produce a result that identifies whether the set of bits has the bit pattern and that identifies a location of the bit pattern in the set of bits;
(b) means for inserting one or more bits in the first subset of bits relative to the bit pattern if the set of bits has the bit pattern; and
(c) means for transmitting in the outgoing bitstream the first subset of bits with any inserted bits at a speed of at least 14.4 kbps.

14. The apparatus of claim 13, wherein the means for processing comprises means for performing operations equivalent to producing one or more other sets of bits from the set of bits and logically combining the set of bits and/or the one or more other sets of bits to produce the result.

15. A method comprising:
(a) receiving an incoming bitstream at a speed of at least 14.4 kbps;
(b) processing a set of a plurality of bits from the incoming bitstream to identify whether the set of bits has a bit pattern, wherein the processing comprises performing operations on the set of bits to produce a result that identifies whether the set of bits has the bit pattern and that identifies a location of the bit pattern in the set of bits;
(c) if the set of bits has the bit pattern, identifying whether an identified bit pattern in the set of bits comprises data bits; and
(d) removing one or more bits in the set of bits relative to the identified bit pattern if the identified bit pattern comprises data bits.

16. The method of claim 15, wherein the processing comprises performing operations equivalent to producing one or more other sets of bits from the set of bits and logically combining the set of bits and/or the one or more other sets of bits to produce the result.

17. The method of claim 16, wherein the processing comprises producing one or more other sets of bits from the set of bits and logically combining the set of bits and/or the one or more other sets of bits to produce the result.

18. The method of claim 16, wherein the processing comprises:
(i) producing one or more other sets of bits from the set of bits,
(ii) logically combining the set of bits and/or the one or more other sets of bits produced from the set of bits to produce a first intermediate result,
(iii) producing one or more other sets of bits from the first intermediate result, and
(iv) logically combining the first intermediate result and/or the one or more other sets of bits produced from the first intermediate result to produce a second intermediate result.

19. The method of claim 16, wherein the producing one or more other sets of bits from the set of bits comprises shifting and/or inverting the set of bits.

20. The method of claim 16, wherein the logically combining the set of bits and/or the one or more other sets of bits comprises performing a logical AND operation on the set of bits and/or the one or more other sets of bits.

21. An apparatus comprising:
(a) a first interface to receive an incoming bitstream at a speed of at least 14.4 kbps;
(b) a processor to process a set of a plurality of bits from the incoming bitstream to identify whether the set of bits has a bit pattern,
wherein the processor is to perform operations on the set of bits to produce a result that identifies whether the set of bits has the bit pattern and that identifies a location of the bit pattern in the set of bits,
wherein the processor is to identify whether an identified bit pattern in the set of bits comprises data bits, and
wherein the processor is to remove one or more bits in the set of bits relative to the identified bit pattern if the identified bit pattern comprises data bits; and
(c) a second interface to transmit the set of bits to data terminal equipment.

22. The apparatus of claim 21, wherein the processor is to perform operations equivalent to producing one or more other sets of bits from the set of bits and logically combine the set of bits and/or the one or more other sets of bits to produce the result.

23. The apparatus of claim 22, wherein the processor is to produce one or more other sets of bits from the set of bits and logically combine the set of bits and/or the one or more other sets of bits to produce the result.

24. The apparatus of claim 22, wherein the processor is to produce one or more other sets of bits from the set of bits, logically combine the set of bits and/or the one or more other sets of bits produced from the set of bits to produce a first intermediate result, produce one or more other sets of bits from the first intermediate result, and logically combine the first intermediate result and/or the one or more other sets of bits produced from the first intermediate result to produce a second intermediate result.

25. The apparatus of claim 22, wherein the processor is to produce one or more other sets of bits from the set of bits by shifting and/or inverting the set of bits.

26. The apparatus of claim 22, wherein the processor is to logically combine the set of bits and/or the one or more other sets of bits by performing a logical AND operation on the set of bits and/or the one or more other sets of bits.

27. An apparatus comprising:
(a) means for receiving an incoming bitstream at a speed of at least 14.4 kbps;
(b) means for processing a set of a plurality of bits from the incoming bitstream to identify whether the set of bits has a bit pattern, wherein the means for processing comprises means for performing operations on the set of bits to produce a result that identifies whether the set of bits has the bit pattern and that identifies a location of the bit pattern in the set of bits;
(c) means for identifying whether an identified bit pattern in the set of bits comprises data bits; and
(d) means for removing one or more bits in the set of bits relative to the identified bit pattern if the identified bit pattern comprises data bits.

28. The apparatus of claim 27, wherein the means for processing comprises means for performing operations equivalent to producing one or more other sets of bits from the set of bits and logically combining the set of bits and/or the one or more other sets of bits to produce the result.
